(19) United States
(12) Patent Application Publication
(10) Pub. No.: US 2024/0063498 A1
(43) Pub. Date: Feb. 22, 2024

(54) BATTERY SYSTEM AND VEHICLE INCLUDING THE BATTERY SYSTEM

(71) Applicant: SAMSUNG SDI CO., LTD., Yongin-si (KR)

(72) Inventor: Andreas Pröll, Helfenberg (AT)

(21) Appl. No.: 18/233,801

(22) Filed: Aug. 14, 2023

(30) Foreign Application Priority Data
Aug. 16, 2022 (EP) 22190567.2
Aug. 10, 2023 (KR) 10-2023-0105043

(51) Int. Cl. H01M 50/333; H01M 50/271

(52) U.S. Cl. CPC H01M 50/333; H01M 50/271; H01M 2220/20

(57) ABSTRACT

A battery system includes: a battery pack including a housing, a battery cell accommodated within the housing, a housing cover sealing the battery pack with the housing, and a reflection plate arranged at a backside of the housing cover. The battery cell has a venting exit in a venting side, and the housing cover forms a venting channel and includes a guide projection on a frontside thereof. The guide projection projects towards the venting exit into the venting channel and is configured to guide a venting gas stream exhausted through the venting exit into the venting channel. An air gap is formed between the reflection plate and the guide projection.

### CROSS-REFERENCE TO RELATED APPLICATION

This application claims priority to and the benefit of European Patent Application No. 22190567.2, filed in the European Patent Office on Aug. 16, 2022, and Korean Patent Application No. 10-2023-0105043, filed in the Korean Intellectual Property Office on Aug. 10, 2023, the entire content of both of which are incorporated herein by reference.

### BACKGROUND

### 1. Field

Aspects of embodiments of the present disclosure relate to a battery system and a vehicle including the battery system.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

A venting concept for a battery in the related art is to let the hot venting gas stream of a battery cell in a thermal runaway condition exit the battery cell(s), expand into the battery housing, and escape through a housing venting valve to the outside (e.g., to the environment of the battery housing). The venting gas stream thereby heats up the battery housing, including parts of the battery housing opposite the venting exits of the battery cells, such as a housing cover. This leads to very high temperatures on the outer surface of the battery pack, which poses a risk to bystanders and to personnel handling the battery system as they may get burned when coming in contact with the outer side of the battery housing. Also, surrounding components may ignite.

Further, the venting gas stream may include hot and toxic venting gas as well as conductive solid matter (or material), such as graphite powder and metal fragments. Such electrically conductive material may deposit on electrically active parts, including terminals and busbars on top of the battery cells, causing short circuits and arcing. Thus, the thermal runaway of one battery cell could cause short circuits and, thus, consecutive thermal runaway of other battery cells leading to complete damage or deflagration of the battery (e.g., of the battery pack), the battery system, and the vehicle.

### BRIEF SUMMARY

According to embodiments of the present disclosure, a battery system exhibiting improved thermal runaway handling is provided. In more detail, a battery system which more securely handles a thermal runaway of one or more of its battery cells and is safer for bystanders and surrounding components is provided.

The present disclosure is, however, defined by the appended claims and their equivalents. Any disclosure lying outside the scope of the claims and their equivalents is intended for illustrative as well as comparative purposes.

According to one embodiment of the present disclosure, a battery system includes: a battery pack including a housing, a battery cell accommodated within the housing, a housing cover sealing the battery pack with the housing, and a reflection plate arranged at a backside of the housing cover. The battery cell has a venting exit at a venting side of the battery cell. The housing cover forms a venting channel and has, at a frontside thereof, an integrated guide projection projecting towards the venting exit of the battery cell into the venting channel for guiding a venting gas stream exhausted through the venting exit into the venting channel, for example, during a thermal runaway away from the venting exit. An air gap is formed between the reflection plate and the guide projection of the housing cover.

According to another embodiment of the present disclosure, the guide projection is a gas splitting projection configured to split the venting gas stream toward opposite sides of the venting channel. The gas splitting projection may have a tapered shape with a tip facing the venting exit of the battery cell.

The battery system may further include a cell cover element arranged between the venting side of the battery cell and the housing cover. The cell cover element may cover the battery cell and its electrical connectors and has an opening aligned with the venting exit of the battery cell.

The housing cover and the cell cover element may be connected to one another in a force and/or form-locking manner.

The reflection plate may be clinched or brazed to the housing cover or may be connected to the housing cover via sealed rivets.

The housing cover may be elastically clamped between the reflection plate and the cell cover element. The housing cover may act as a clamping-spring to clamp the cell cover element to the venting side of the battery cell.

The housing cover may have higher heat resistance than the reflection plate.

According to another embodiment of the present disclosure, a vehicle includes a battery system as described above.

Additional aspects and features of the present disclosure can be learned from the following description and the appended claims.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a battery system according to an embodiment of the present disclosure.

FIG. 2 is a perspective view of a battery system according to another embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure may, however, be embodied in various different forms and should not be construed as being limited to the embodiments illustrated herein. Rather, these embodiments are provided so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Herein, the terms “upper” and “lower” are defined according to a z-axis. For example, an upper housing cover is positioned at the upper part of the z-axis, and a lower housing cover is positioned at the lower part of the z-axis.

The electrical connections or interconnections described herein may be realized by wires or conducting elements, for example, on a printed circuit board (PCB) or another kind of circuit carrier. The conducting elements may include metallizations, such as surface metallizations, and/or pins and/or may include conductive polymers or ceramics. Further, electrical energy might be transmitted via wireless connections, such as by using electromagnetic radiation and/or light.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system is provided including a battery pack, and the battery pack includes a housing and at least one battery cell accommodated within the housing. In some embodiments, the battery system includes multiple (e.g., a plurality of) battery cells within the housing. The battery cells may be interconnected via busbars contacting respective electrode terminals of the battery cells to form one or more battery modules. The battery cells may be, for example, prismatic or cylindrical cells. The battery cells have venting exits at a venting side thereof, and the venting side may be the terminal side of the battery cells. The venting exits allow a venting gas stream to escape the battery cells during a thermal runaway. Venting valves may be provided at (or in) the venting exits.

The battery system further includes a housing cover sealing the battery pack from the outside. The housing cover is part of the housing. The housing cover may be a cover plate, for example, an upper cover plate arranged at an upper side/top side of the battery system or a lower cover plate arranged at a lower side/bottom side of the battery system. The housing cover may be attached to a base of the housing after the battery cells have been inserted into the housing base. The housing cover seals (e.g., closes) the housing to the outside (e.g., to the environment of the battery system). The housing cover, in combination with further parts of the housing, such as the housing base, may seal the inside of the battery housing from the outside of the battery housing such that a venting gas stream exhausted by one or more battery cells during a thermal runaway may escape the battery housing and, thus, the battery system only at passages provided for this purpose, such as through at a venting valve arranged in a housing wall of the housing. The housing cover may seal the battery pack from the outside in an airtight manner.

The housing cover forms a venting channel, that is, a channel for receiving and directing the venting gas stream exiting the at least one battery cell during a thermal runaway, and for leading away this venting gas stream from the battery cell towards the outside, for example, via a venting valve arranged in a housing wall. The housing cover may form the venting channel in combination with the venting side of the battery cell(s) or with a cell cover element arranged at the venting side of the battery cell(s), as explained in more detail below.

The housing cover has a frontside facing the venting exit of the battery cell and a backside opposite the frontside, that is, facing away from the venting exit. At the frontside of the housing cover, a guide projection, for example, a projecting element for guiding the venting gas stream, is arranged. The guide projection may be an integrated guide projection (e.g., it may be an integral part of the housing cover). In other words, the housing cover may form the guide projection at its frontside. The guide projection may be a protrusion into or toward the housing cover. The guide projection projects towards the venting exit of the at least one battery cell and, thus, projects into the venting channel. The guide projection is configured to guide the venting gas stream exhausted through the venting exit of the battery cell during a thermal runaway event away from the venting exit. The guide projection may be configured to split the venting gas stream in two substreams and to direct these substreams in opposite directions away from one another, as will be explained in more detail below. The guide projection leads the venting gas stream away from the venting exit and from the battery cell along the venting channel. This allows for the venting gas stream to be transported away quickly and reliably. Also, the venting gas stream is cooled down via heat transfer to surrounding elements, such as to the walls of the venting channel, the housing cover, and the venting side of the battery cells or the cell cover element. The guide projection may also reduce a pressure drop from occurring during exhausting of the venting gas stream by having an aerodynamically efficient design and may act as a collector for molten particles, which are carried with the venting gas stream.

Further, the battery system, according to embodiments of the present disclosure, may include a reflection plate arranged at the backside of the housing cover. The reflection plate, or a combination of the reflection plate and the housing cover, is configured to form an air gap between the reflection plate and the guide projection of the housing cover. For example, a free space is confined between the reflection plate and the housing cover, and the free space is filled with air. This free space is formed between the housing cover and the reflection plate at the position of the guide projection, for example, at the backside of the guide projection. As mentioned, the guide projection may be formed as a protrusion in the frontside of the housing cover. Thus, a corresponding dent or depression may be formed at the backside of the housing cover. The reflection plate may cover this dent or depression, thereby forming the air gap between the reflection plate and the housing cover. The reflection plate may form part of the housing of the battery system. For example, because the reflection plate is arranged at the backside and, thus, the outer side of the housing cover, the reflection plate may be accessible from the outside. The reflection plate is configured to reflect heat radiation, including infrared radiation.

During a thermal runaway, the housing cover and its guide projection heats up substantially due to receiving heat energy from the venting gas stream. This heat traverses the housing cover to the outer side of the housing cover via conduction. From there, the heat may be conducted to the surrounding air and via radiation. The reflection plate arranged at the outer side of the housing cover, at least at the position of the guide projection, however, reflects the heat radiation, including infrared radiation, emitted by the heated housing cover (e.g., by the heated guide projection), thus reducing energy absorption by the reflection plate. Further, the air gap arranged between the housing cover and the reflection plate acts as a thermal insulator to the reflection plate. As a result, heat transfer from the housing cover to the reflection plate is further reduced. Thus, the reflection plate, and the outer side of the battery system, are prevented from dangerously heating up. Embodiments of the present disclosure thereby provide significantly lower heating of the outer surface of the housing/battery system than related art cover plates. This reduces the risk of injuries to bystanders that may come into contact with the outer side of the battery system by reducing the risk of burns. Also, ignition of surrounding components in a vehicle including the battery system is mitigated or prevented.

According to an embodiment, the guide projection is a gas splitting projection configured to split the venting gas stream such that the venting gas stream is deflected to opposite sides of the venting channel. In some embodiments, the gas splitting projection has a tapered shape with a tip facing (e.g., aligned with) the venting exit of the corresponding battery cell. The gas splitting projection may split the venting gas stream in two substreams flowing along opposite directions (e.g., perpendicular to a longitudinal extension of the venting channel). The tip of the gas splitting projection may be arranged directly opposite the venting exit centrally to the venting exit so that the venting gas stream exhausted through the venting exit centrally hits the tip and is split in two substantially equal substreams. The gas splitting projection thus allows for even distribution of the venting gas stream along a width of the venting channel (e.g., in directions perpendicular to a longitudinal extension of the venting channel). The venting gas stream is transported away quickly and reliably. Also, the venting gas stream is cooled down via heat transfer to surrounding elements, such as to the walls of the venting channel, the housing cover, and the venting side of the battery cells or the cell cover element. Thus, embodiments of the present disclosure provide more effective distribution of the venting gases within the venting channel and, thus, more effective cooling.

According to an embodiment, the battery system further includes a cell cover element arranged between the venting side of the at least one battery cell and the housing cover. The cell cover element covers the at least one battery cell including its electrical connectors (e.g., cell terminals and/or busbars connecting the battery cell to further battery cells of the battery system). The cell cover element further includes at least one opening aligned with the venting exit of the at least one battery cell so that the venting gas stream exiting the venting exit may pass through the cell cover element. The cell cover element covers the at least one battery cell, including its electrical connectors, such that the venting gas stream does not come into contact with the venting side of the cell cover element and does not come into contact with the electrical connectors. Thus, the cell cover element shields the electrical connectors from the venting gas stream, including from any conductive material present in the venting gas stream which might otherwise cause a short circuit if deposited onto the electrical connectors. Such conductive material may instead be deposited onto the cell cover element or the gas splitting projection or may be transported away with the venting gas stream along the venting channel. The venting channel may be formed between the cell cover element and the housing cover. The cell cover element thus protects the electrical elements of the battery cell from the venting gas stream to prevent short-circuits.

According to an embodiment, the housing cover and the cell cover element are connected to one another in a force and/or form-locking manner.

According to an embodiment, the housing cover is elastically clamped between the reflection plate and the cell cover element. In such an embodiment, the housing cover may act as a clamping-spring to clamp the cell cover element to the venting side of the at least one battery cell. The housing cover may include spring elements to provide the clamping. The spring elements may be integral to the housing cover. The spring elements may be (or may form) leaf springs. In other words, the housing cover may have a curved shape, and the spring elements may be formed by the curves in the housing cover and act like a leaf spring. Thus, this arrangement holds down (e.g., secures) the cell cover element by elastic deformation. This allows for simple manufacture and easier disassembly for rework or recycling.

According to an embodiment, the reflection plate may be clinched or brazed to the housing cover or connected to the housing cover via sealed rivets. The housing cover and the reflection plate may thus be joined in a way that is impervious to temperature and provides high thermal resistance.

According to an embodiment, the housing cover has higher heat resistance than the reflection plate. The housing cover may have higher heat resistance than the reflection plate due to a different choice of materials, meaning that the housing cover may be made of a material having higher heat resistance than the material of the reflection plate. The housing cover may be made of, for example, steel. The reflection plate may be made of a material with a low emissivity, meaning that it reflects most of the heat/infrared radiation. For example, the reflection plate may be made of aluminum, which has low emissivity. In other embodiments, the reflection plate may be made of ceramics having low emissivity. In some embodiments, the reflection plate may include a coating to provide low emissivity. This allows for the housing cover to endure the high temperatures of the venting gas stream.

Embodiments of the present disclosure also include a vehicle including a battery system as described herein.

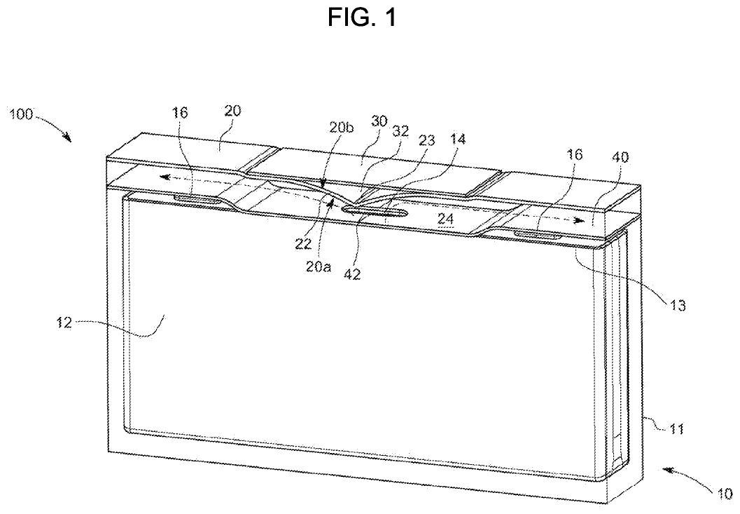

FIG. 1 is a perspective view of a battery system 100 according to an embodiment of the present disclosure. The battery system 100 includes a battery pack 10 including a housing 11 and multiple battery cells 12 accommodated within the housing 11 (FIG. 1 shows only one of the battery cells 12). Each of the battery cells 12 has a venting exit 14 at a venting side 13 of the battery cell 12 and which is configured to release a venting gas stream exit the battery cell 12 during a thermal runaway occurring inside the battery cell 12.

A housing cover 20 of the housing 11 seals the battery pack 10 from the outside and forms, together with a cell cover element 40, a venting channel 24. The housing cover 20 has a frontside 20a with an integrated guide projection 22 projecting towards the venting exit 14 of the battery cell 12 into the venting channel 24. The guide projection 22 is a gas splitting projection with a tapered shape with a tip 23 facing (e.g., aligned over) the venting exit 14. The housing cover 20 may be made of steel.

The cell cover element 40 is arranged between the venting side 13 of the battery cell 12 and the housing cover 20 and covers the battery cell 12, including its electrical connectors 16 (e.g., electrode terminals and/or busbars interconnecting this battery cell with another battery cell 12 in the battery pack 10). The cell cover element 40 has an opening 42 aligned with the venting exit 14 of the battery cell 12 to let venting gases pass through the cell cover element 40.

A reflection plate 30 is arranged at a backside 20b of the housing cover 20 opposite the frontside 20a such that an air gap 32 is formed between the reflection plate 30 and the guide projection 22 of the housing cover 20. The reflection plate 30 may be clinched or brazed to the housing cover 20 or connected to the housing cover 20 via sealed rivets. The reflection plate 30 may be made of aluminum.

During a thermal runaway event occurring in the battery cell 12, a venting gas stream is exhausted via the venting exit 14, passes through the opening 42 in the cell cover element 40, and hits (e.g., reaches) the guide projection 22. The venting gas stream is split by the guide projection 22 into two substreams of substantially equal volume, and the two substreams are deflected to opposite sides of the venting channel 24 as indicated in FIG. 1 via dotted arrows. Material present in the venting gas stream may deposit onto the guide projection 22.

The housing cover 20 and, in particular, the guide projection 22 are thus subjected to the very high temperatures of the venting gas stream. Accordingly, the housing cover 20 is made of a highly temperature resistant material, such as steel. The reflection plate 30 is arranged at the outer side of the housing cover 20 facing the backside 20b of the guide projection 22 to reflect heat radiation, including infrared radiation, emitted by the heated housing cover 20 and guide projection 22. Thus, less energy (e.g., thermal energy) is absorbed by the reflection plate 30.

Further, the air gap 32 arranged between the housing cover 20 and the reflection plate 30 acts as a thermal insulator for the reflection plate 30. As a result, the heat transfer from the housing cover 20 to the reflection plate 30 is further reduced.

Thus, the reflection plate 30 as well as the outer side of the battery system 100 are not heated up to dangerous temperatures during a thermal runaway. Embodiments of the present disclosure thus provide significantly lower heating of the outer surface of the battery system 100 than related art cover plates. This reduces the risk of injuries to bystanders that may come into contact with the outer side of the battery system 100. Also, ignition of surrounding components in a vehicle including the battery system 100 are mitigated or prevented.

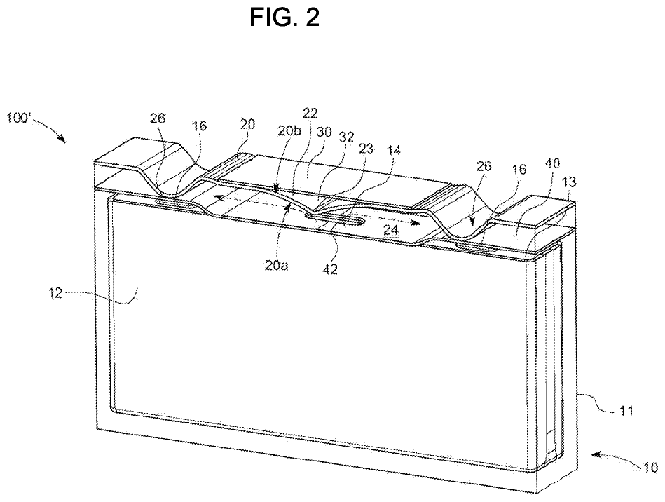

FIG. 2 is a perspective view illustrating a battery system 100′ according to another embodiment of the present disclosure.

The battery system 100′ differs from the battery system 100 shown in FIG. 1 in that the housing cover 20 includes integral spring elements 26. In this embodiment, the housing cover 20 is pressed against the cell cover element 40 by the reflection plate 30. Thus, the housing cover 20 acts as a clamping-spring for clamping the cell cover element 40 to the venting side 13 of the battery cell 12.

This allows for relatively simple construction without the need for a connection device or component between the housing cover 20 and the cell cover element 40.

### SOME REFERENCE NUMERALS

10 battery pack
11 housing
12 battery cell
13 venting side
14 venting exit
16 electrical connecting means
20 housing cover
20a frontside
20b backside
22 guide projection
23 tip
24 venting channel
26 spring element
30 reflection plate
32 air gap
40 cell cover element
42 opening
100 battery system
100′ battery system

What is claimed is:

1. A battery system comprising:
a battery pack comprising a housing, a battery cell accommodated within the housing, a housing cover sealing the battery pack with the housing, and a reflection plate arranged at a backside of the housing cover,
wherein the battery cell has a venting exit in a venting side,
wherein the housing cover forms a venting channel and comprises a guide projection on a frontside thereof, the guide projection projecting towards the venting exit into the venting channel and being configured to guide a venting gas stream exhausted through the venting exit into the venting channel, and
wherein an air gap is formed between the reflection plate and the guide projection.

2. The battery system according to claim 1, wherein the guide projection is a gas splitting projection configured to split the venting gas stream toward opposite sides of the venting channel.

3. The battery system according to claim 2, wherein the gas splitting projection has a tapered shape with a tip facing the venting exit.

4. The battery system according to claim 1, further comprising a cell cover element between the venting side and the housing cover,
wherein the cell cover element covers electrical connectors of the battery cell and has an opening aligned with the venting exit of the battery cell.

5. The battery system according to claim 4, wherein the housing cover and the cell cover element are connected to one another in a form-locking manner.

6. The battery system according to claim 4, wherein the housing cover is elastically clamped between the reflection plate and the cell cover element.

7. The battery system according to claim 4, wherein the housing cover acts as a clamping-spring and clamps the cell cover element to the venting side of the battery cell.

8. The battery system according to claim 1, wherein the reflection plate is clinched or brazed to the housing cover.

9. The battery system according to claim 1, wherein the reflection plate is connected to the housing cover via sealed rivets.

10. The battery system according to claim 1, wherein the housing cover has higher heat resistance than the reflection plate.

11. A vehicle comprising the battery system according to claim 1.
